(19) United States
(12) Patent Application Publication
(10) Pub. No.: US 2008/0109336 A1
(43) Pub. Date: May 8, 2008

(54) Independent sales organization toolbox (ISO) internet software system

(76) Inventor: James Lyndsay Isett, Moorpark, CA (US)

Correspondence Address: JAMES L. ISETT, 4619 BIG COUNTRY CT, MOORPARK, CA, 93021, US

(21) Appl. No.: 11/592,302

(22) Filed: Nov. 3, 2006

(51) Int. Cl. G06Q 40/00

(52) U.S. Cl. 705/35

(57) ABSTRACT

The acquiring of transactional payments and merchant processing within the payments industry can be seen as a shifting business model that reflects the desires of financial sales and service organizations, from multiple channels, as well as entrepreneurial individuals, to engage in various aspects of the merchant payments processing business. With this in mind the ISO Toolbox System is a software solution-designed and developed for the purpose of enabling these types of businesses to manage all aspect of sales, contract underwriting, transaction processing, settlement and customer servicing of sales channels, financial service organizations and customers themselves. The system processing capabilities required to engage in this type of business necessitate the utilization of state-of-the-art software engineered and that can be prepared as a “turn-key” system solution to meet the needs of organizations operating in this industry. At the present there is no single system solution capable of enablement of an enterprise to begin operating in all aspects of the business on a single platform, maintained in-house and capable of being operated over the Internet. For this reason the ISO Toolbox to be developed to provide capabilities for sales and service organizations to have access to and utilize this suite of applications to fully enable back-office support and processing for customers of any mainframe merchant system processing company. This product will be developed in multiple phases. The ISO Toolbox Solutions will provide customers desiring to gain process efficiencies for the strategic and operational needs necessary to support a merchant payments processing business. The system solution will be an Internet based application that can supply any ISO using the solution the capability of tracking customer handling and support all operational capabilities and efficiencies related to account acquisition and setup. In addition, additional efficiencies will be gained from the system's proposed integration between platforms to which it has interface capabilities. These capabilities will provide support for the tracking of accounts in the pipeline as well as management reporting at multiple levels. The software application will also provide the quantitative information needed to support for the sales channel compensation and reporting needs, customer servicing needs and all aspects of operational automation and reporting.

The inventor has designed and developed a software product in a Foxpro DOS that will be converted to an Internet software application and introduced in the electronic payments industry for both U.S. Domestic and the international market place. The overall processing platform and infrastructure has numerous components and will continue to be developed in various stages as it is converted to an Internet Based Solution. The overall system is comprised of numerous subsystems; each having a particular function within the overall operations and systems and applications. All software components referenced herein are considered to be an Independent Sales Organization's (ISO) “toolbox” type application. The toolbox concept is derived from the fact that a sales organization would be capable of having all need systems and functional components of an operating infrastructure to be capable of managing and developing their unique businesses and customer base. This toolbox solution is based upon an Internet infrastructure with information storage and retrieval capabilities needed to run an operation of the payments processing variety.

### PRODUCT DESCRIPTION

The system provides functionality including Account Management and Acquisition Processing, reporting and data flow automation inclusive of online application data entry, credit underwriting, credit bureau scoring interfaces, automated account setup, customer file maintenance, secure and encrypted storage and retention of data, complete sales force management, compensation processing, pricing and profitability reporting, back-office support applications necessary for customer services (management, administration personnel, merchant customers, sales channels, operations departments), Risk management, funds management, dual entry accounting process, Automated Clearing House (ACH) interfaces with banking channels to provide movement of funds and associated accounting capability for ISO services.

The ISO Toolbox will be programmed as capable of multiple layers of reporting requirements and requisites (both online as well as manual environments), data storage and reformatting in conventional reporting tools and files, such as Microsoft office products as well as interfaces with third party processors, banks, customers, other businesses and other peripheral entities involved with the payments industry all part of the processing system interfaces based upon the import and export data between platforms.

Internet processing environment consisting of web-site hosting, data security and exchange, retention and housing all of the customer data, online real-time access using state-of-the-art techniques and while utilizing industry leading security and data storage techniques such as datawarehouse processing and structures will provide the infrastructure on which the ISO Toolbox will operate on.

The underlying database engine is powered by standard SQL query capability. The database design, the maintenance features and utility functions of the core product are the same technology is used to run all applications; the Toolbox solutions will essentially be applications tailored to various markets and users all receiving the same processing capabilities from the framework of the existing solutions enabling the Toolbox solutions to be built one time and usable as an infrastructure of supporting other applications to be developed.

Product is already designed to interface with and utilize all Microsoft software used in most environments including Excel, Word, Access, Foxpro, and others thereby enabling users of these products to feed data into the database or extract data from the database to tailor to the user's ability to be self supporting with those tools.

The logic and database engine enables the rapid development and deployment of major applications without redundant coding, QA testing and other time consuming use of resources since the logic and business rules of the database are contained directly in the database and not in source code written to use the database.

Toolbox solutions can enable large and small numbers of users to have the same processing power and a nearly infinite number of concurrent open users and operators to use the same database with negligible performance degradation to the database allowing varying numbers of users to have different views, reports, merges, exports and imports all open on the internet server.

Architecture of the database and its logic components is based on a standardized set of engineering rules that allow massive databases made with a large numbers of tables to be joined together with high throughput and performance speeds.

Changes can be made to any application without any user ever leaving the system to get the changes immediately integrated into the system at the same time they are in it.

Architecture of the database and its logic components is based on a standardized set of rules that are actually in the database and can be modified, added to or removed without ever changing any program running in the application. The application layer does not need to have redundant code, procedures or other interface instructions to be modified upon changes to the database or its rules.

The Toolbox solutions allow the users to define the Word documents, Excel spreadsheets, imports and exports as a part of the database and with this feature can make the system perform the tasks previously dependent on technologists making programming changes and the overhead associated with those resources.

What is claimed is:

1. There is currently (as of September 2006) not a single turn-key system solution available in any market capable of providing end-to-end solutions specific to the payments industry back-office operations running completely in the internet environment; resulting in the lack of a fully integrated back-office system solution capable of data import and export capabilities that support all aspects of sales management, marketing to and monitoring of the customer base, sales channels and operational resources simultaneously.

2. The “toolbox” application and the infrastructure are both technically and systemically designed to enable the same processing capability anywhere in the world via the internet thus it is engineered as a software application being written to be capable of providing systemic solutions meeting the needs of businesses requiring complete connectivity with most of the major third-party payments processors currently operating within the U.S. domestic as well as the International markets while the system is also going to be developed to also run in a stand-alone network application to provide a fail-over processing capability for emergency reasons.

3. There is no single end-to-end back-office solution capable of running in an internet environment specific to the payments industry although there are some internet based applications claiming some functionality and uniqueness regarding various reporting ability, such systems have been created to function for the purpose of meeting single needs of sales organizations within the payments industry.
The ISO Toolbox will be capable of providing a generic set of product features to any ISO using the services regardless of the third-party vendors or processors and is engineered to be a standard product and processing system that can be private labeled by any ISO that seeking a systemic solution to enable the entity to establish and manage processing relationships with multiple underwriting banks, multiple third party processors (both front and back-end) and allow all such servicing to be done via the Internet environment. The “toolbox” solution makes any merchant acquirer and/or sales organization customers capable of selecting from a broad range of support systems and services that are enabled through conventional and standardized internet based graphic user interfaces (GUI) and protocols.

4. There are currently no identifiable patents recorded making the claim of being a single software application running in an internet environment designed to be a single set of source code modules capable of dynamic currency conversions and other global considerations relative to the ISO environment.

5. The ISO toolbox solution is maintained as a single software application and all source code will be patented and copyright protected. The application, as proprietary software, will be made available through the licensing of the services provided by the host processing company. The developing company (Iseft) will be responsible for managing the systems environment required for the solution as well as supporting all marketed products.

6. No software solution available on the domestic or international market enable full dual entry accounting processes to be combined with the operational components of the Independent Sales Organizations business functionality. The ISO Toolbox will contain complete General Ledger, Accounts Payable, Accounts Receivables, Payroll and other general accounting processing and reporting.
1. ISO Toolbox Solutions will have multi-currency conversion and accounting capability, Billing and Payables interfaces with ACH Processing and the entire interfacing product solutions designed, developed and implemented
2. Future applications will be translated into many different languages such as English, Spanish, Mandarin, Arabic, Italian, Portuguese, etc. This feature will enable the sales and deployment of the ISO Toolbox solutions to international markets not having any competing or comparable products or capabilities.

7. All regulating associations and governmental standards are adhered to in the Internet based application. At this time there is no known and marketed software capable of meeting the rules associated with Visa™/Mastercard™ in a real-time and online system but the toolbox solution is designed according to the requirements and by-laws established by the payments industry associations, regulators, governmental and other agencies with responsibility for ensuring such compliance is met.

8. Data security and protective measures as well as all privacy are maintained through multiple levels of encryption and firewalls within the Internet processing environment and the toolbox application will develop new third tier security measures based on database access and user privileges that have no comparable methods in an internet environment.
The ISO Toolbox is designed to be fully Payment Card Industry (PCI) compliant in meeting all of the standards published in September 2006. The fulfillment of all PCI Standards will be standard and meet all requirements both in an in-house system and infrastructure as well as all external access points given entry and access to the system and ISO Toolbox solutions.

9. There is no single source of maintenance for a software solution running in the internet environment that enables a “real-time” support and maintenance for the payments industry application to be effective immediately to all users, both online and off-line, while business is being conducted and they are still online. The ISO Toolbox does not require users to exit the systems in order to perform maintenance or updates to data, programming or telecomm interfaces.
In addition to the business functionality of the internet based software solution all data security, compliance, accounting, bankcard association rules and requirements as well as those of other legal and recognized entities within the payments arena will be met by the software solution and its ongoing maintenance and support.

10. Interrelated subsystem components specific to the payments industry are selected by system users in real-time mode. This feature enables system administration to be handled in accordance with customer demands, centralized security and control points and audit trail interfaces completely within an internet based solution.

11. The ISO “toolbox” system is the only payments industry specific Internet application capable of computing its own billing and accounting audit trails as the transactions, services, user activations and other product specific functions are actively being engaged in a real-time environment.
